(19) United States
(12) Patent Application Publication
(10) Pub. No.: US 2009/0190920 A1
(43) Pub. Date: Jul. 30, 2009

(54) OPTICAL APPARATUS

(75) Inventor: Toshihiro OHTANI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/338,508

(22) Filed: Dec. 18, 2008

(30) Foreign Application Priority Data
Dec. 20, 2007 (JP) 2007-328592

(51) Int. Cl. H04B 10/00

(52) U.S. Cl. 398/7

(57) ABSTRACT

An optical apparatus connected to an up and a down transmission lines, comprising an optical amplifier including an optical amplification medium and an excitation light source. The excitation light source supplies an excitation light to the optical amplification medium. An optical supervisory channel (OSC) unit receives OSC optical signals from, and transmits the OSC optical signals to, the up and the down transmission lines. If an output power decrease of the excitation light source due to an random failure is detected, the excitation light is kept unchanged and the OSC unit transmits information of the random failure of the excitation light source via the OSC optical signals to the up and the down transmission lines, and if the OSC unit receives information of an random failure of an excitation light source in another optical apparatus, the output light power of the excitation light source is increased.

### CROSS-REFERENCE TO RELATED APPLICATIONS

This application is based upon and claims the benefit of priority of the prior Japanese Patent Application No. 2007-328592, filed on Dec. 20, 2007, the entire contents of which are incorporated herein by reference.

### BACKGROUND OF THE INVENTION

1. Field of the Invention

The present invention relates to an optical transmission system that amplifies an optical signal using optical amplifiers and relays/transmits the optical signal. The present invention includes a control technique that allows the signal transmission to be maintained even when the output of an excitation LD in the optical transmission system decreases.

2. Description of the Related Art

Optical amplifiers are required in an optical transmission system that transmits/receives a wavelength division multiplexed (WDM) optical signal to combine a high power output property with a low-noise property successfully. The high power output property enables an amplification output to be increased in accordance with an increase in wavelength number of the WDM optical signal. The low-noise property enables a decrease in an optical signal-to-noise ratio (OSNR) of the optical signal to be inhibited after amplification.

FIG. 9 illustrates a conventional optical amplifier with a two-stage configuration, in which two optical amplifiers 110 and 120 are connected in series and the optical signal is amplified in two stages. The conventional optical amplifiers used in WDM optical transmission system are disclosed in WO2002/021203 or Japanese Unexamined Patent Application Publication No. 4-271330.

As shown in FIG. 9, an excitation method for exciting an erbium doped optical fiber (EDF) employs excitation light with a wavelength of 0.98 μm is applied to a pre-stage optical amplification section 110 (hereinafter, this method is referred to as a “0.98 μm excitation method”). An optical fiber doped with erbium is used as an optical amplification medium in a two-stage configured optical amplifier with an erbium doped fiber amplifier (EDFA). A low-noise property can be achieved by applying the 0.98 μm excitation method to the pre-stage optical amplification section 110. An optical signal supplied into an input port is amplified up once to an intermediate level by the pre-stage optical amplification section 110. Then, the optical signal is amplified up to a desired level by the post-stage optical amplification section 120. As shown in FIG. 9, an excitation method that allows a high power output to be realized by exciting the EDF using excitation light with a wavelength of 1.48 μm has hitherto been often adopted in the post-stage optical amplification section 120 (hereinafter, this method is referred to as a “1.48 μm excitation method”). Furthermore, the 0.98 μm excitation method has been more frequently applied also to the post-stage optical amplification section 120 with the trend of recent semiconductor lasers toward a higher output.

However, the excitation LD (expressed as LD 111 in a configuration example in FIG. 9) used in the 0.98 μm excitation method can decrease in output and result in a failure in a short time. This phenomenon, referred to as an “abrupt halt”, constitutes a significant problem. The abrupt halt is mainly attributable to the oxidation of a material such as aluminum contained in an active layer of the semiconductor laser. In the abrupt halt phenomenon, the excited laser light is absorbed by the active layer due to the oxidation of the contained material in the active layer, and owing to heat generated by absorption of the laser light, the percentage of the laser light of being further absorbed increases. Thus, the heating value continues to increase in a chain reaction manner, and the laser element itself ultimately ends up burning out. On the other hand, regarding the excitation LD used in the 1.48 μm excitation method, because the active layer does not contain a material such as aluminum that causes oxidation, a rapid output power decrease due to the abrupt halt does not basically occur.

The factors contributing to the output power decrease in the 0.98 μm excitation LD include a failure due to wear (hereinafter, referred to as a “wear-out failure”), and an random failure. The wear-out failure is a slow degradation mode wherein the decrease of the output power in the excitation LD progresses in units of years. Specifically, the wear-out failure is a failure in which, out of injected current, current that does not contribute to light-emitting increases with time, so that the characteristic of an optical output with respect to the injected current gradually degrades. That is, the wear-out failure corresponds to a so-called “lifetime”.

On the other hand, the random failure is a fast degradation mode in which the decrease of the output power in the excitation LD progresses in a short time (specifically, in about 100 hours or less). Random failures include a failure due to a posteriori factor in which the neighborhood of an end face of the excitation LD, wherein the energy density is high, is melted due to momentary high optical output oscillation owing to an inflow of surge current or an overcurrent from the outside, to thereby form crystal defects; and a failure due to a priori factor in which there exist crystal defects in a semiconductor manufacturing process (i.e., during manufacturing). The above-described abrupt halt is subsumed under the random failure.

When the laser output power decreases due to crystal defects, since the crystal defects occur in a non-light-emitting area, the injected current changes into heat in this area. In addition, because the non-light-emitting area absorbs light, the non-light-emitting area also generates heat. These occurrences of heat lead to enlargement of crystal defects in a chain reaction manner, thereby causing a rapid decrease in the laser output as in the case of the above-described abrupt halt.

In the conventional optical amplifier, when an output power decrease in the 0.98 μm excitation LD occurs, control for compensating for the output power decrease has been performed within the pertinent optical amplifier in its closed state. Specifically, in the configuration example in FIG. 9, when the output of the 0.98 μm excitation LD 111 decreases, control for making excitation light power constant by increasing a drive current with respect to the 0.98 μm excitation LD 111 is performed by an output monitor 112 and a drive control circuit 113, irrespective of whether the output power decrease is attributable to a wear-out failure or an random failure. When the degradation of the 0.98 μm excitation LD 111 progresses so as to make it difficult to constant-output control and the pre-stage optical amplification section 110 becomes short of output, control for increasing the excitation light power of the optical amplification section 120 is performed by an output monitor 122 and a drive control circuit 123, in order to keep the output of the entirety of the optical amplifiers constant.

### SUMMARY OF THE INVENTION

An optical apparatus connected to an up transmission line and a down transmission line, comprising an optical amplifier configured to amplify a light input from the up transmission line, including an optical amplification medium and an excitation light source, the excitation light source supplying an excitation light to the optical amplification medium; an optical supervisory channel (OSC) unit configured to receive OSC optical signals from, and transmit the OSC optical signals to, the up transmission line and the down transmission line; wherein, if an output power decrease of the excitation light source due to an random failure is detected, a driving condition of the excitation light is kept unchanged and the OSC unit transmits an information of the random failure of the excitation light source via the OSC optical signals, to the up transmission line and the down transmission line, and if the OSC unit receives an information of an random failure of an excitation light source in other optical apparatus connected to the up transmission line and the down transmission line, the output light power of the excitation light source is increased.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 is a block diagram showing a configuration of an optical transmission system according to a first embodiment of the present invention;

FIG. 2 is a block diagram showing a configuration of an optical amplifier in each station in the first embodiment;

FIG. 3 is a diagram showing operations when an output power decrease has occurred in an excitation LD in a station B in the first embodiment;

FIG. 4 is a diagram showing an OSNR improvement effect in the first embodiment;

FIG. 5 is a block diagram of showing another configuration of an optical amplifier related to the first embodiment;

FIG. 6 is a diagram showing a modification that is related to the first embodiment and that is configured to transmit output power decrease information on excitation LDs in all the stations to each station, the output power decrease information being superimposed on an optical supervisory channel (OSC) signal;

FIG. 7 is a block diagram showing a configuration of an optical transmission system according to a second embodiment of the present invention;

FIG. 8 is a block diagram showing another configuration of an optical transmission system related to the second embodiment;

FIG. 9 is a block diagram showing a configuration of a conventional optical amplifier;

FIGS. 10A to 10c are diagrams showing operations when a wear-out failure has occurred in the conventional optical amplifier, and FIGS. 10D to 10F are diagrams showing operations when an random failure has occurred therein; and

FIG. 11 is a diagram showing a temporal change in the output power of an excitation LD wherein an random failure has occurred.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

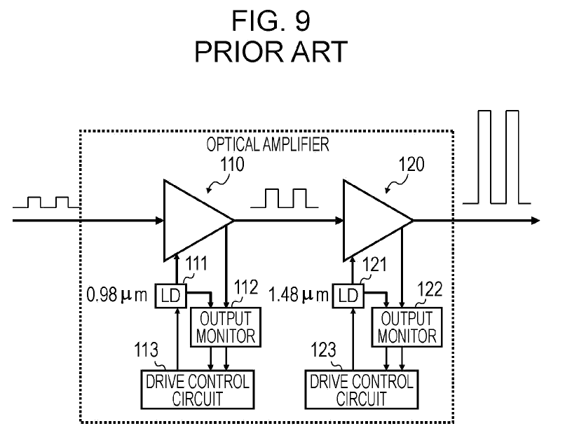

When the output power decrease in the excitation LD arises from the random failure as described above, the aforesaid control with respect to the output power decrease in the excitation LD in the conventional optical amplifier has a disadvantage of accelerating the progression of an random failure by keeping the output of the excitation LD constant. If the random failure progresses in a shorter time, it would be necessary to perform replacement of the excitation LD in which an output power decrease has occurred earlier, which raises a problem of increasing the burden on a maintainer. Such a problem occurs not only in the above-described two-stage optical amplifier shown in FIG. 9, but also in various types of configurations of optical amplifiers that are equipped with excitation LDs in which a rapid output power decrease due to an random failure can occur and that make constant-output control with respect to the excitation LDs.

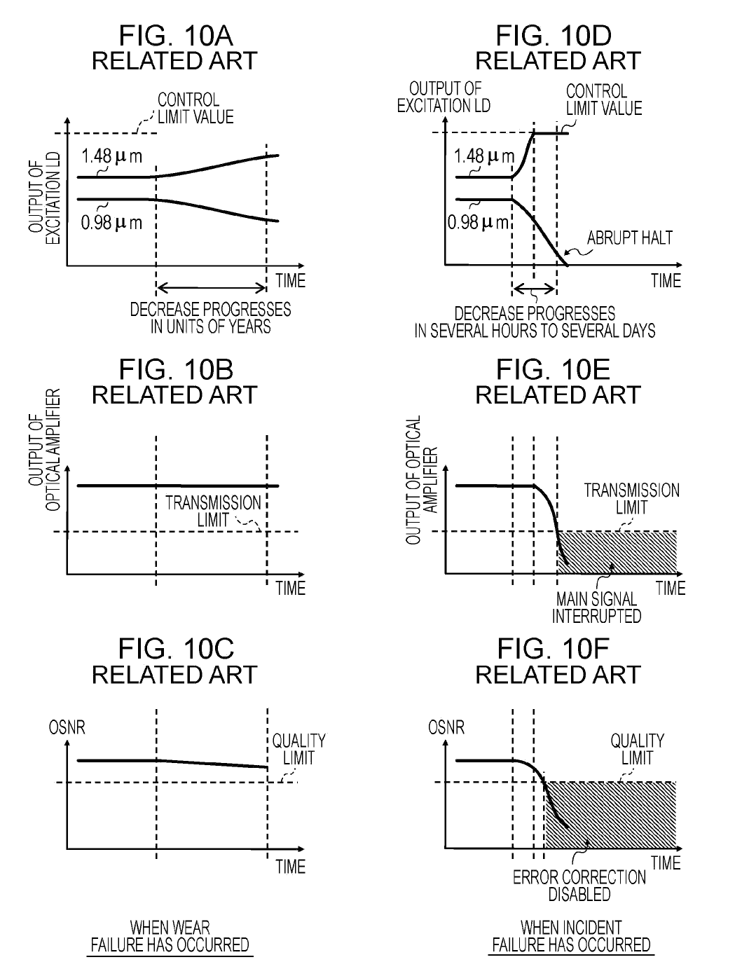

As a related art, in order to avoid the above-described acceleration of the random failure, for example, there is control for keeping the entire optical amplifier constant by increasing excitation light power of the post-stage optical amplifier, while maintaining the drive condition of the excitation LD in which an output power decrease has occurred. Regarding operating characteristics of an optical amplifier when the above-described control is applied, FIGS. 10A to 10F provide a comparison between the case in which a wear-out failure has occurred (FIGS. 10A to 10C) and the case in which an random failure has occurred (FIGS. 10D to 10F). Under such control, however, when the 1.48 μm excitation method is applied to the post-stage optical amplifier, the OSNR of amplified light rapidly decreases with an increase in the output of the 1.48 μm excitation LD. That is, before the output of the 0.98 μm excitation LD substantially vanishes, making the amplification of optical signal difficult, the OSNR significantly decreases so as to make error correction processing at a receiving terminal impossible, thus causing a problem of disabling signal transmission.

At the occurrence of a wear-out failure shown in FIGS. 10A to 10C, when the output of the 0.98 μm excitation LD gradually decreases in a progression in units of years, the output level of optical signal of the entire optical amplifier (FIG. 10B) is kept constant by increasing the output of the 1.48 μm excitation LD in accordance with the output power decrease (FIG. 10A). At this time, the OSNR of the optical signal outputted from the optical amplifier meets a quality limit level while the value of OSNR somewhat decreases (FIG. 10C), and a signal transmission is normally performed by error correction processing at the receiving terminal.

On the other hand, at the occurrence of an random failure shown in FIGS. 10D to 10F, when the output of the 0.98 μm excitation LD rapidly decreases in a progression within a range from several hours to several days, the output of the 1.48 μm excitation LD is increased so as to keep the output level of optical signal of the entire optical amplifier constant, but at a point in time when the control of the 1.48 μm excitation LD reaches the upper limit, the signal output level of the optical amplifier rapidly decreases (FIGS. 10D and 10E). At this time, the OSNR of the optical signal outputted from the optical amplifier rapidly decreases with the output power decrease in the 0.98 μm excitation LD. That is, before the signal output power of the optical amplifier falls short of the transmission limit level to thereby enter a state of main signal interruption, the OSNR becomes unable to meet the quality limit level and makes error correction processing at the receiving terminal incomplete, thus degrading signal transmission (FIG. 10F).

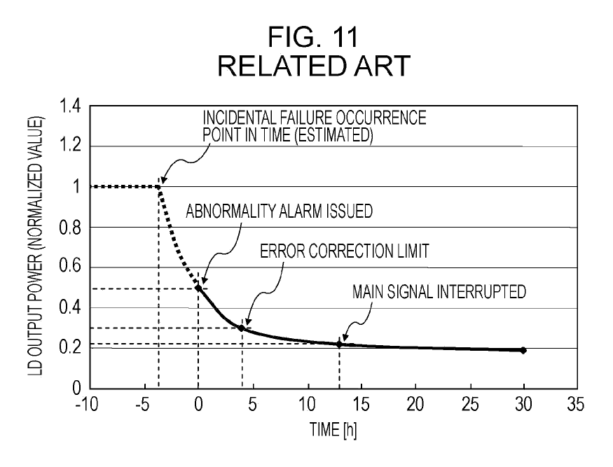

FIG. 11 shows, on the basis of a measurement by a related art, how an output of the 0.98 μm excitation LD used in the EDFA decreases at the occurrence of an random failure. Here, the vertical axis denotes values obtained by normalizing the output powers of the 0.98 μm excitation LD under constant-output control by a level during normal operation, and the horizontal axis denotes elapsed time from the point in time when an alarm indicative of an occurrence of abnormality in drive current of the excitation LD is issued. In FIG. 11, several hours after the random failure occurrence time point that is estimated from the point in time when the abnormality alarm is issued, the output power rapidly decreases to thereby reach the error correction limit, and then in several days, an effective laser output becomes unable to be obtained, eventually ending up in main signal interruption.

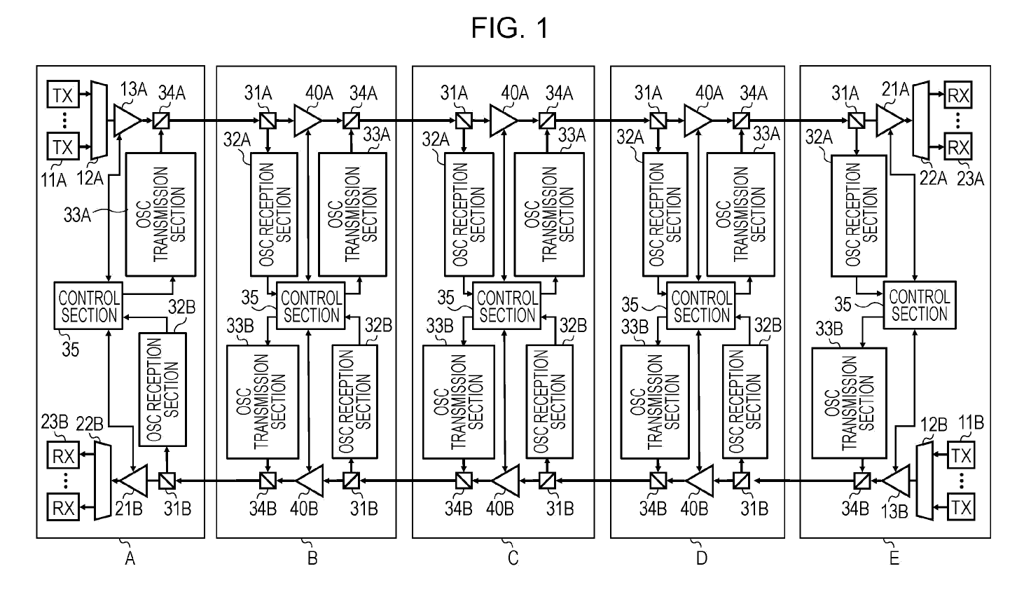

FIG. 1 is a block diagram showing the configuration of an optical transmission system with optical amplifiers, according to a first embodiment of the present invention.

In FIG. 1, a plurality of stations A to E are connected to one another by a set of optical transmission lines corresponding to up and down lines arranged through the stations A to E. WDM optical signal transmitted from a terminal station A to the up line is relayed/transmitted through relay stations B, C, and D in this order, while being amplified in the respective relay stations, and received by a terminal station E. On the other hand, the WDM optical signal transmitted from the terminal station E to the down line is relayed/transmitted through the relay stations D, C, and B in this order, while being amplified in the respective relay stations, and received by the terminal station A.

Furthermore, the stations A to E exchange information among themselves using an optical supervisory channel (OSC) signal that is a signal of a different channel from that of the WDM optical signal (main optical signal). Information transmitted by the OSC signal includes output decrements in excitation LDs incorporated in optical amplifiers in each of the stations. If an random failure occurs in any excitation LD in the present optical transmission system, the present system shares the output power decrease in the excitation LD among all the stations and controls optical amplifiers by each of the stations on the basis of the output decrement, to thereby compensate for the above-described output power decrease in the excitation LD by the system in its entirety.

Specifically, the terminal station A wavelength-multiplexes respective optical signal lights that are mutually different in wavelength and that are outputted from a plurality of transmitters (TX) 11A, by an optical multiplexer 12A, and amplifies them up to a desired level by an optical amplifier 13A for transmission. Then, the terminal station A multiplexes the WDM optical signal outputted from the optical amplifier 13A for transmission with an OSC signal created by an OSC transmission section 33A, by an multiplexer 34A, and transmits the WDM optical signal and the OSC signal to the up line. Moreover, the terminal station A receives light transmitted through the down line, and separates the light into the WDM optical signal and the OSC signal by the demultiplexer 31B.

Then, after the terminal station A has amplified the separated WDM optical signal up to a desired level by an optical amplifier 21B for reception, separates the WDM optical signal into optical signal lights with respective wavelengths by the demultiplexer 22B, and receives them by receivers (RX) 23B corresponding to respective optical signal lights. The OSC signal separated by the demultiplexer 31B is received by an OSC reception section 32B, and supervisory control information is transmitted to a control section 35. On the basis of this information, the control section 35 controls the optical amplifier 13A on the up-line side and the optical amplifier 21B on the down-line side.

Each of the relay stations B to D receives light that has been outputted from the upstream station on the up-line side and that has propagated through the optical transmission line. Each of the relay stations B to D separates the light into WDM optical signal and an OSC signal by a demultiplexer 31A. Then, each of the relay stations B to D amplifies the WDM optical signal by the optical amplifier 40A to thereby compensate for loss on the optical transmission line, and outputs the WDM optical signal to the optical transmission line connected to the downstream station on the up-line side via a multiplexer 34A. The OSC signal separated by the above-described demultiplexer 31A is received by the OSC reception section 32A, and the supervisory control information is transmitted to the control section 35. Also, each of the relay stations B to D receives light that has outputted from the upstream station on the down-line side and that has propagated through the optical transmission line, and separates the light into the WDM optical signal and the OSC signal by the demultiplexer 31B. Then, each of the relay stations B to D amplifies the WDM optical signal by the optical amplifier 40B to thereby compensate for loss on the optical transmission line, and outputs the WDM optical signal to the optical transmission line connected to the downstream station on the down-line side via a multiplexer 34B.

The OSC signal separated by the above-described demultiplexer 31B is received by the OSC reception section 32B, and the supervisory control information is transmitted to the control section 35. The control section 35 controls the optical amplifiers 40A and 40B on the basis of the supervisory control information from the OSC reception sections 32A and 32B, respectively. Furthermore, upon receipt of monitor information on operation states of the optical amplifiers 40A and 40B in its own station, the control section 35 creates information to be transmitted to the downstream station on the up-line side and the down-line side, and outputs the information to the corresponding OSC transmission sections 33A and 33B. In response of the information from the control section 35, the OSC transmission sections 33A and 33B create OSC signals, and after having multiplexed them with the main optical signal by the multiplexers 34A and 34B, transmit the multiplexed signal to the optical transmission line.

The terminal station E receives light transmitted through the up line, and after having separated the light into the WDM optical signal and the OSC signal by the demultiplexer 31A, amplifies the separated WDM optical signal up to a desired level by an optical amplifier 21A for reception. Then, the terminal station E separates the WDM optical signal into optical signal lights with respective wavelengths by a demultiplexer 22A, and receives them by receivers (RX) 23A corresponding to respective optical signal lights. The OSC signal separated by the above-described demultiplexer 31A is received by the OSC reception section 32A, and supervisory control information is transmitted to the control section 35.

Also, the terminal station E wavelength-multiplexes respective optical signal lights that are mutually different in wavelength and that are outputted from a plurality of transmitters (TX) 11B, by an optical multiplexer 12B, and amplifies them up to a desired level by an optical amplifier 13B for transmission. Then, the terminal station E multiplexes the WDM optical signal outputted from the optical amplifier 13B with an OSC signal created by the OSC transmission section 33B, by the multiplexer 34B, and transmits the WDM optical signal and the OSC signal to the down line. On the basis of the supervisory control information from the OSC reception section 32A, the control section 35 controls the optical amplifier 21A on the up-line side and the optical amplifier 13B on the down-line side.

Here, configurations of optical amplifiers in the stations A to E: 13A, 13B, 21A, 21B, 40A, and 40B are described in detail.

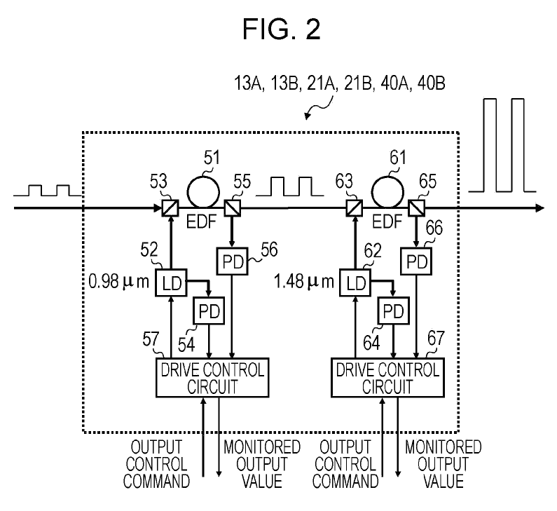

FIG. 2 is a block diagram showing a specific example of optical amplifier. This optical amplifier has a two-stage configuration in which an EDFA by 0.98 μm excitation method is used as a pre-stage optical amplification section, and an EDFA by 1.48 μm excitation method is used as a post-stage optical amplification section. The pre-stage optical amplification section once amplifies the WDM optical signal to propagate through an EDF 51, up to an intermediate level by supplying excitation light outputted from the a 0.98 μm excitation LD (LD) 52 to an EDF 51 into one end of which the WDM optical signal is inputted, via a multiplier 53. At this time, excitation light power outputted from the 0.98 μm excitation LD 52 is monitored by a photo detector (PD) 54, and the monitored result is sent to a drive control circuit 57.

The WDM optical signal amplified by the EDF 51 is sent to a post-stage optical amplification section, and a part thereof is provided to an optical detector (PD) 56 after have been branched by an optical coupler 55. Then, the signal output power of the pre-stage optical amplifier is monitored by the above-described optical detector 56, and the monitored result is sent to the drive control circuit 57. The drive control circuit 57 outputs the monitored results by the optical detectors 54 and 56 to the control section 35 (refer to FIG. 1), and upon receipt of an output control command from the control section 35, controls the drive condition of the 0.98 μm excitation LD 52. By this drive control circuit 57, during normal operation, the 0.98 μm excitation LD 52 is subjected to constant-output control in accordance with the output control command, while, when the output power decreases due to the occurrence of an random failure, the 0.98 μm excitation LD is freed from the constant-output control, and its drive condition at that time is maintained.

The post-stage optical amplification section amplifies the WDM optical signal to propagate through an EDF 61, up to a desired power level by supplying excitation light outputted from the a 1.48 μm excitation LD (LD) 62 to an EDF 61 into one end of which the WDM optical signal amplified in the pre-stage optical amplifier is inputted, via a multiplier 63. At this time, excitation light power outputted from the 1.48 μm excitation LD 62 is monitored by a photo detector (PD) 64, and the monitored result is sent to a drive control circuit 67. The WDM optical signal amplified by the EDF 61 is sent to an optical amplifier (PD) 66, and a part thereof is provided to an optical detector (PD) 66 after have been branched by an optical coupler 65. Then, the signal power of the post-stage optical amplification section is monitored by the optical detector 66, and the monitored result is sent to the drive control circuit 67. The drive control circuit 67 outputs the monitored results by the optical detectors 64 and 66 to the control section 35 (refer to FIG. 1), and in accordance with an output control command from the control section 35, the drive control circuit 67 performs constant-output control with respect to the 1.48 μm excitation LD 62.

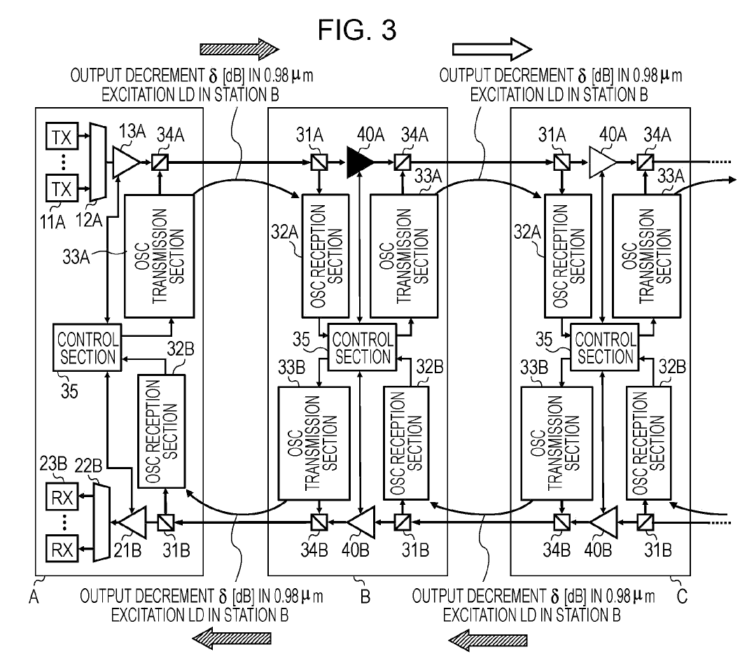

FIG. 3 is a diagram showing operations when an output power decrease occurs in the excitation LD in the station B in the optical transmission system according to the first embodiment. As shown in FIG. 3, when an output power decrease occurs in a 0.98 μm excitation LD 52 (refer to FIG. 2) provided in the optical amplifier 40A on the up-line side in the relay station B, an output decrement δ [dB] of the 0.98 μm excitation LD 52 in the station B is transmitted to each of the other stations A, and C to E making use of the OSC signal.

Here, detailed description is made of the transmission of the output decrement δ making use of the OSC signal between the stations A to E. In the optical transmission system performing relay/transmission of WDM optical signal, typically, information exchange is performed between stations on the system using the OSC signal set in a channel other than that of main optical signal. This OSC signal superimposes thereon control information for remotely controlling other stations from a terminal device connected to some station, or operation information for WDM optical signal (for example, information on number of a channel that is in the service-in, a signal output level set in each of the stations, status information at starting-up, etc).

In the present embodiment, when an output power decrease occurs in the 0.98 μm excitation LD 52 in any station (in the example in FIG. 3, station B), information for specifying the pertinent LD 52 and the output decrement δ are added to the OSC signal. This output decrement δ is determined on the basis of how much the excitation light power monitored by the optical detector 54 has decreased relative to a target level of constant-output control during normal operation. As indicated by a hollow arrow in FIG. 3, such an OSC signal including the output decrement δ is transmitted to the up line from the station B in which an output power decrease in the 0.98 μm excitation LD 52 has occurred, and sequentially transmitted to the stations C to E on the downstream side. Furthermore, as indicated by hatched arrows in FIG. 3, the OSC signal is transmitted also to the station A on the upstream side through the down line. Thus, all the stations A to E on the system share there among information indicating that the output decrement δ [dB] has occurred in the 0.98 μm excitation LD 52.

Upon receipt of the above-described output power decrease information, the control sections 35 in the stations A to E transition into a control mode for boosting in unison outputs of excitation LDs that are normally operating in the optical amplifiers on the up-line side in accordance with the output decrement δ of the 0.98 μm excitation LD 52 in the optical amplifier 40A on the up-line side in the station B, so that the output power decrease in the 0.98 μm excitation LD 52 in the station B is compensated for by the system in its entirety.

Specifically, the control section 35 in the station B in which an output power decrease in the 0.98 μm excitation LD 52 has occurred, regarding the optical amplifier 40A on the up-line side, maintains the current drive condition of the 0.98 μm excitation LD 52 in the pre-stage EDFA (i.e., controls drive current to be constant), and creates an output control command to increase the output power of the 1.48 μm excitation LD 62 in the post-stage EDFA by a predetermined amount. The output control command is outputted to each of the drive control circuits 57 and 67 in the optical amplifier 40A, and thus the drive conditions of the excitation LDs 52 and 62 are controlled, respectively. Also, the control sections 35 in the other stations A, and C to E each creates an output control command to increase each of the output powers of the 0.98 μm excitation LD 52 and the 1.48 μm excitation LD 62 in the optical amplifier 40A on the up-line side by a predetermined amount. The output control command is outputted to each of the drive control circuits 57 and 67 in the optical amplifier 40A, and the drive conditions of the excitation LDs 52 and 62 are controlled, respectively.

Here, an example in which the drive condition of the 0.98 μm excitation LD 52 in which an output power decrease has occurred is maintained, has been shown. Alternatively, however, one may reduce the drive current of the 0.98 μm excitation LD 52 down to a preset level to retard the progression of the random failure.

In the control mode as described above, the increment in output power of an excitation LD that is normally operating can be determined, for example, in accordance with the following procedure. First, a table in which increments in output powers of excitation LDs for compensating for an output power decrease by the entire system have been calculated for each of the output decrements δ of the 0.98 μm excitation LDs 52 in which a failure has occurred, is created in advance. Then, the table is stored in a memory (not shown) provided in each of the control sections 35 in the stations A to E, and a value corresponding to the output decrement δ of the 0.98 μm excitation LD 52 transmitted by the OSC signal is read from the above-described memory table to determine the above-described increment in output power.

Here, a concrete example regarding calculation method in the above-described table is described.

In general, when optical signal with a power Pin [dBm] is inputted to an optical amplifier having a characteristic of a noise index NF [dB], the OSNR value [dB] of optical signal outputted from the pertinent optical amplifier is expressed by the following equation (1) where α is a constant.

OSNR=Pin−NF+α (1)

Also, the OSNR value [dB] of optical signal at a reception terminal in an optical transmission system that relays optical signal in multi-stages, as shown in FIG. 1, is expressed by the following equation (2).

OSNR_{receive}=−10×log [Σ{10(−0.1×OSNR)}] (2)

Here, in order to distinguish from the OSNR value of an output signal of the optical amplifier alone shown by the above-described equation (1), the OSNR value of the optical signal at the reception terminal in the optical transmission system is denoted as OSNR_{receive}. As is evident from the equation (2), the OSNR value of optical signal at the reception terminal is a sum of OSNR values of output signals in all the optical amplifiers existing on the paths through which the optical signal is relayed/transmitted.

In the case in which the two-stage optical amplifiers as shown in FIG. 2 are provided in each station on the optical transmission system, and an output power decrease has occurred in the 0.98 μm excitation LD in the optical amplifier in some station, if the decrement in the excitation light power is known, the input power of optical signal to the post-stage optical amplification section can be calculated. Moreover, the NF value of the optical amplification section in each stage after the output power decrease can also be grasped in advance on the basis of design information. As a result, from these pieces of information, the OSNR value of the output signal in the optical amplifier in which the output power decrease has occurred in the 0.98 μm excitation LD can be determined on the basis of the relationship in the equation (1). Also regarding each of stations on the downstream of the pertinent optical amplifier, if the output decrement in the 0.98 μm excitation LD on the upstream side is known, the power of optical signal inputted to its own station can be calculated, and also the NF value at that time can be grasped in advance on the basis of design information. Therefore, the OSNR value of optical signal outputted from each of the stations can be determined on the basis of the relationship in the equation (1).

As described above, since the OSNR value at the reception terminal of the optical transmission system is a sum of the OSNR values of output signals of the optical amplifiers in all the stations, the OSNR value of optical signal at the reception terminal can be calculated in accordance with the output decrement, irrespective of which station on the system has been decreased in the output in its excitation LD. Therefore, if the output decrement in the excitation LD is shared among all the stations, then, in accordance with the output decrement, it is possible to determine drive conditions of optical amplifiers in each of the stations, such as to meet a lower limit value of the OSNR value of optical signal at the reception terminal (this lower limit corresponds to quality limit, for example), the lower limit value being defined by specifications or the like.

Specifically, during the output power decrease in the excitation LD, since the OSNR value of optical signal of the pertinent optical amplifier decreases, the value of the sum total (Σ) in the right side of the above-described equation (2) becomes smaller than during the normal state. At that time, regarding other excitation LDs that are normally operating, their drive condition are controlled so that their respective output power levels is boosted in unison so that the OSNR values of output signals in the optical amplifiers corresponding to the respective excitation LDs may be increased. For example, considering the case in FIG. 3, individual increments of output powers of the above-described other LDs that are normally operating can be determined by dividing the output decrement δ in the 0.98 μm excitation LD in the station B by the number of all the excitation LDs on the up-line side that are normally operating.

Regarding the number of excitation LDs that are normally operating, because the total number of excitation LDs on the system is known on the basis of design information, the number of excitation LDs that are normally operating can be obtained by utilizing the design information. Also, if an optical switch for switching the transmission line of optical signal is provided on the system and the total number of excitation LDs on the system changes, then, the number of the excitation LDs that are normally operating can be obtained by transmitting information on the total number of excitation LDs, being superimposed on the OSC signal, to each of the stations.

As a result, the decrement in the OSNR value in an optical amplifier in which an output power decrease in the excitation LD has occurred is compensated for by increments of the OSNR values of the other optical amplifiers. This allows the OSNR value of optical signal at the reception terminal to be kept at a level equal to that in a normal state, or at least at a level such as not to cause a signal transmission problem.

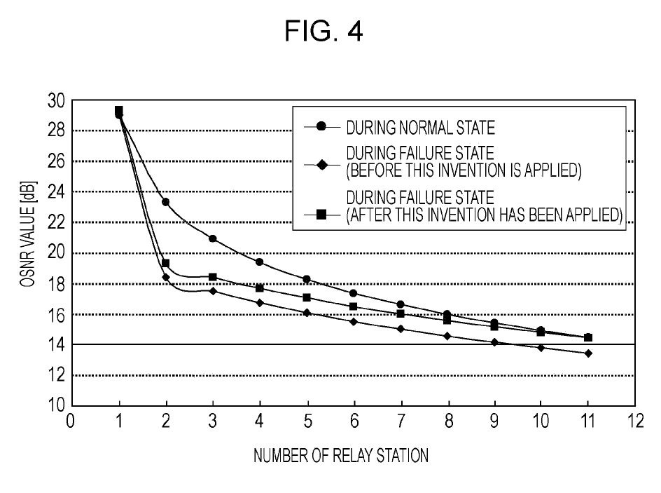

FIG. 4 shows a specific example of an OSNR improvement effect in the present optical transmission system as describe above. Here, however, a transmission system in which there exist eleven stations inclusive of a transmission terminal and a reception terminal is assumed, and changes in OSNR value of optical signal when an output power decrease has occurred in the 0.98 μm excitation LD in a second station are calculated.

The curve corresponding to round symbols in FIG. 4 shows OSNR values of optical signal during normal state in which no output power decrease has occurred in the excitation LDs on the system. Here, the OSNR value of optical signal at a reception terminal (the eleventh station) is 14.5 [dB]. When an output power decrease occurs in the 0.98 μm excitation LD in the second station, before the above-described control by the present invention is applied, the OSNR value of optical signal at the reception terminal decreases down to 13.5 [dB], as shown in the curve corresponding to rhomboid symbols in FIG. 4.

Assuming the lower limit of OSNR value (quality limit) at the reception terminal to be 14.0 [dB], the above-described output value (13.5 [dB]) falls short of the lower limit of OSNR value, which indicates that the optical transmission system is in a state of being incapable of normal signal transmission. So, the control by the present invention is applied as follows: the output power decrease in the 0.98 μm excitation LD in the second station is shared among all the stations, and the drive conditions of excitation LDs that are normally operating are controlled so that signal output levels of optical amplifiers corresponding to the respective excitation LDs are raised by, e.g., 2 dB. Thereupon, as shown in the curve corresponding to square symbols in FIG. 4, the OSNR value of optical signal at the reception terminal returns to 14.5 [dB], which is the value in the normal state. That is, since the OSNR value exceeds the quality limit of 14.0 [dB], the state of being capable of signal transmission is maintained although the output power decrease has been occurred in the 0.98 μm excitation LD in the second station.

In a typical optical amplifier such as an EDFA, when the output power of excitation LD is increased by 10%, the signal output level of the optical amplifier rises by about 1 dB. When the output power of excitation LD is increased by 20%, the signal level of the optical amplifier rises by about 2 dB. When such a relationship holds, in order to implement the state exemplified in FIG. 4, it is advisable to increase the output power of the excitation LDs that are normally operating by about 20%. However, the present invention is not limited to the above-described specific example.

As described above, according to the optical transmission system in the first embodiment, even when the output of an excitation LD rapidly decreases due to an random failure, it is possible to maintain the state of being capable of signal transmission for a longer time without accelerating the progression of the random failure, by sharing the output decrement among all the stations on the system by utilizing the OSC signal to maintain the current drive condition of the excitation LD in which the output power decrease has occurred, and regarding the other excitation LDs that are normally operating, by boosting in unison their respective output powers to compensate for the decrease in OSNR due to the output power decrease in the above-described excitation LD by the system in its entirety. This allows securing a sufficient time before the maintainer takes countermeasures against the failure, such as replacement of the excitation LD, thereby enabling a relief of burden on the maintainer.

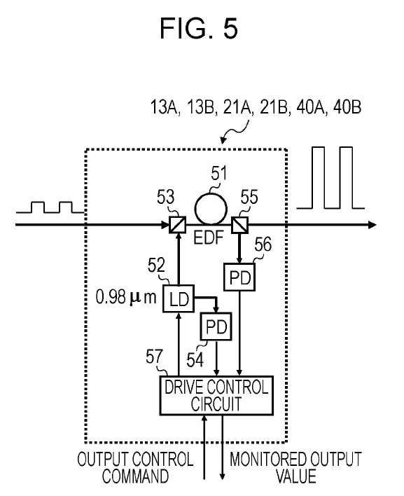

In the above-described first embodiment, description has been made of the two-stage configuration in which, regarding the optical amplifiers in each of the stations, the EDFA by the 0.98 μm excitation method is used as the pre-stage optical amplifier, and the EDFA by the 1.48 μm excitation method is used as the post-stage optical amplifier. However, the configuration of the optical amplifiers in the present invention is not limited to the above-described configuration example. As shown in FIG. 5, for example, the present invention can also be applied as in the case of the above-described first embodiment to a system in which an optical amplifier by the 0.98 μm excitation method, constituted of a single stage of EDFA is provided in each of the stations. Furthermore, for example, while not illustrated, the present invention is also effective to an two-stage optical amplifier in which EDFAs by the 0.98 μm excitation LD method are adopted for both the pre-stage optical amplifier and post-stage optical amplifier, or an optical amplifier by the 0.98 μm excitation method, which has a configuration of multi-stages such as three stages or more and in which at least one stage thereof is provided with an EDFA by 0.98 μm excitation LD method.

Moreover, in the above-described first embodiment, explanation has been made of the case in which the output of the 0.98 μm excitation LD rapidly decreases due to the occurrence of an random failure. However, regarding an excitation LD other than the 0.98 μm excitation LD, the present invention is also applicable to the case in which an excitation LD which has any wavelength, and of which the output power can rapidly decrease in a progression in about 100 hours or less due to the occurrence of an random failure, is used in an optical amplifier.

In addition, in the above-described first embodiment, regarding the 1.48 μm excitation LD existing in the same station as that having the 0.98 μm excitation LD in which output power decrease has occurred, the example in which the output level is raised by the same control as that with respect to the excitation LDs in the other stations, has been shown. However, for example, it is also possible to control the drive condition of 1.48 μm excitation LD so that the signal output level of its own station is kept constant while maintaining the current drive condition of the 0.98 μm excitation LD in which an output power decrease has been occurred. In other words, it is also possible to maintain a constant-output control with respect to its own station up until the control of the 1.48 μm excitation LD reaches the upper limit even if the output power decrease in the 0.98 μm excitation LD has been occurred. In this case, the power of optical signal inputted to a downstream station keeps substantially the same level up until the control of the 1.48 μm excitation LD reaches the upper limit irrespective of the output decrement in the 0.98 μm excitation LD. However, because the OSNR value of optical signal during the time that intervenes decreases in response to an increase in the output power of the 1.48 μm excitation LD (refer to the right side in FIG. 10), it is necessary to let the other stations recognize the decreasing state of the pertinent OSNR value. For this purpose, for example, it is desirable to superimpose the output decrement in the 0.98 μm excitation LD as well as the output increment (or the monitored value of output power) in the 1.48 μm excitation LD in the same station on the OSC signal, to thereby allow these pieces of information to be shared among all the stations on the system. This enables the decrease in the OSNR value of optical signal outputted from the station in which an output power decrease in the 0.98 μm excitation LD has occurred to be judged by the other stations, and allows compensation for the output power decrease to be performed by the system in its entirety.

Furthermore, in the above-described first embodiment, the output decrement δ in the 0.98 μm excitation LD has been transmitted to the other stations by superimposing the output decrement δ on the OSC signal. However, since the output decrement δ in the 0.98 μm excitation LD eventually leads to a decrease in the level of optical signal outputted from the pre-stage optical amplification section, the same control as the above-described control in the first embodiment can be performed also by determining the decrement in the signal output level of the pre-stage optical amplification section using a monitored value by the optical detector 56 (FIG. 2), and superimposing the above-described signal output decrement on the OSC signal to thereby share the signal output decrement among all the stations on the system.

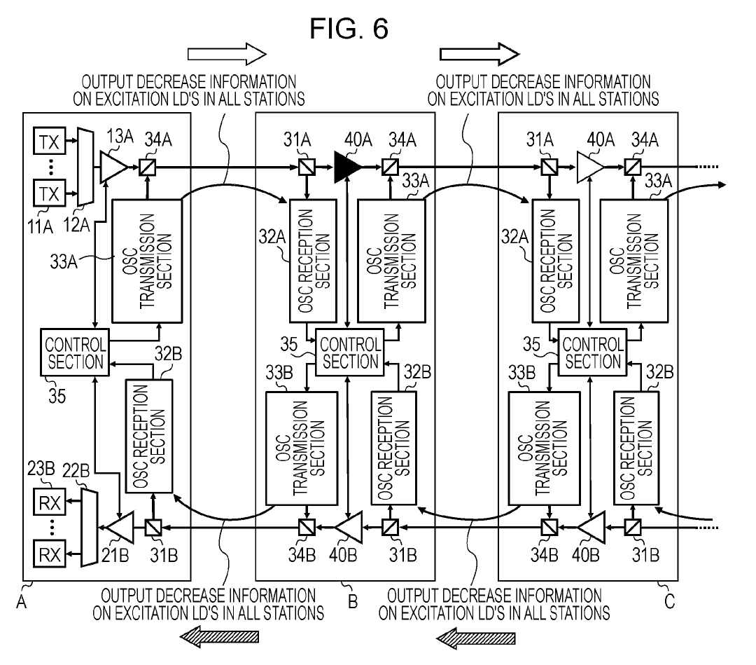

Moreover, as shown in FIG. 6, for example, the output decrements δ of the excitation LDs in all the stations on the system may be superimposed on the OSC signal to thereby be shared among all the stations. In this case, as an output decrement in excitation LDs that are normally operating, 0 [dB] shall be transmitted to each of the stations. In each of the stations, upon determining in which excitation LD an random failure has occurred, the same control as above-described control in the first embodiment is performed.

Next, a second embodiment according to the present invention is described.

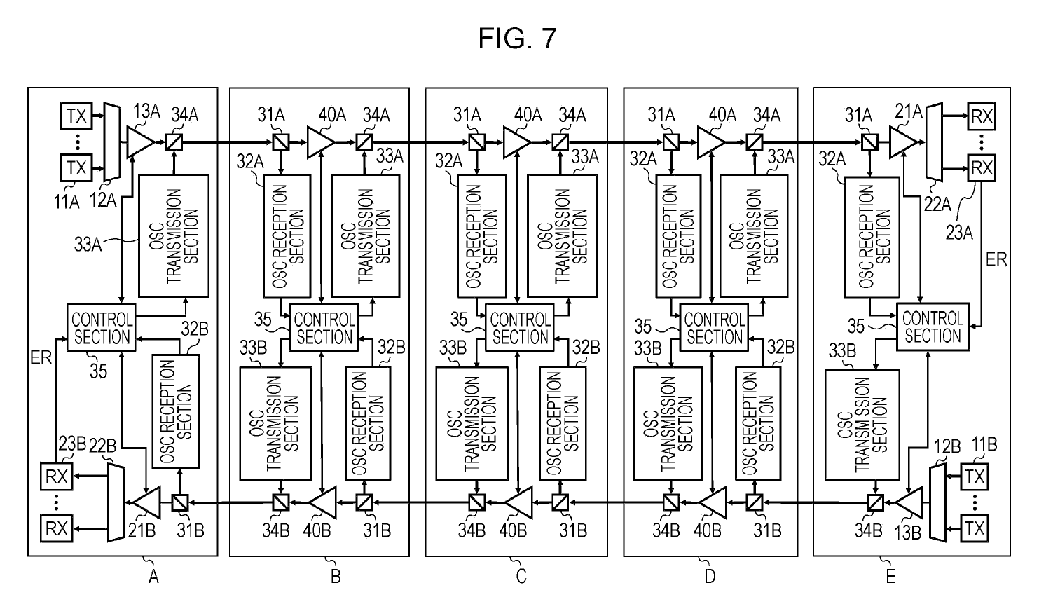

FIG. 7 is a block diagram showing a configuration of an optical transmission system according to the second embodiment.

As shown in FIG. 7, the present optical transmission system is an application of the above-described first embodiment. The present optical transmission system is configured to perform feed-back control with respect to output powers of excitation LDs. The excitation LDs are normally operating in each of the stations so that the OSNR value of optical signal at the reception terminal becomes higher by making use of error information obtained in the process of receiving optical signal by the receivers 23B and 23A in the terminal stations A and E, respectively.

Specifically, for example, in a system transmitting optical signal with a speed of 10 [Gbit/sec] or more, typically, error correction processing is performed at the reception terminal using an error correction code that is imparted to optical signal, and the number of error occurrences in received signals before and after the error correction processing can be counted. Accordingly, in the optical transmission system according to the present embodiment, in each of the terminal stations A and E, a signal ER that indicates the number of error occurrences before or after error correction and that is counted by the respective receiver 23B and 23A is provided to the respective control sections 35, so that an OSC signal including the above-described number of error occurrences is created by the respective transmission sections 33A and 33B, and is transmitted to each of the stations on the upstream side of the reception terminal via the opposed lines. In each of the stations, which have received the number of error occurrences at the reception terminal, the increment in output power of the excitation LD in its own station, set in accordance with the output decrement δ of the 0.98 μm excitation LD, is optimized so that the number of error occurrences becomes a minimum. This allows the decrease in OSNR caused by the rapid output power decrease in the excitation LD due to an random failure to be compensated for by the entirety of the system, with high accuracy.

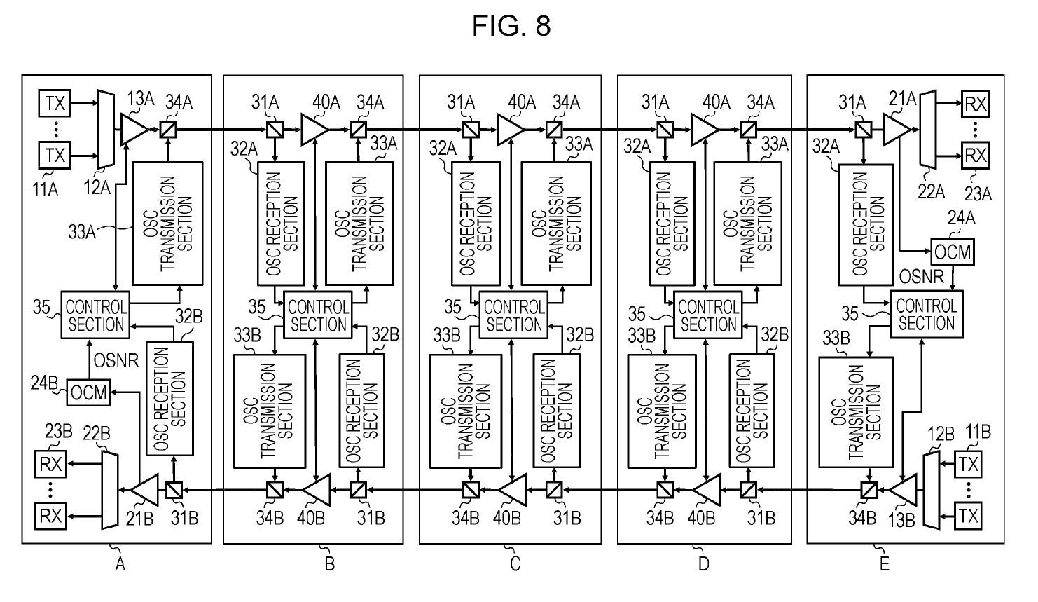

In the above-described second embodiment, the example has been shown in which the control with respect to the excitation LD in each of the stations is optimized using the number of error occurrences counted during the error correction at the reception terminal. Alternatively, as shown in FIG. 8, for example, the following control method may be used in which an optical channel monitor (OCM) modules 24B and 24A that can measure power or OSNR of optical signal are attached to the reception section in the terminal stations A and E, respectively, to thereby directly monitor OSNR values of reception light using the above-described OCM modules, and the monitored results are transmitted to each of the stations, being superimposed on the OSC signal, whereby the excitation LD in each of the stations is subjected to feedback control such that the monitored OSNR value becomes a maximum.

According to the above-described embodiments, in the optical transmission system with optical amplifiers, even when a rapid output power decrease in the excitation LD due to an random failure occurs, it is possible to provide a control technique for maintaining the state of being capable of signal transmission for as long a time as possible without accelerating the degradation of the pertinent excitation LD, and securing a sufficient time before the maintainer takes countermeasures against a failure, thereby enabling a relief of burden on the maintainer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical apparatus connected to an up transmission line and a down transmission line, comprising:
an optical amplifier configured to amplify a light input from the up transmission line, including an optical amplification medium and an excitation light source, the excitation light source supplying an excitation light to the optical amplification medium;
an optical supervisory channel (OSC) unit configured to receive OSC optical signals from, and transmit the OSC optical signals to, the up transmission line and the down transmission line; wherein,
if an output power decrease of the excitation light source due to an random failure is detected, a driving condition of the excitation light is kept unchanged and the OSC unit transmits an information of the random failure of the excitation light source via the OSC optical signals to the up transmission line and the down transmission line, and
if the OSC unit receives an information of an random failure of an excitation light source in another optical apparatus connected to the up transmission line and the down transmission line, the output light power of the excitation light source is increased.

2. The optical apparatus according to claim 1, wherein the excitation light source outputs the excitation light with a wavelength of 0.98 μm.

3. The optical apparatus according to claim 1, wherein the random failure of the excitation light source is caused by a crystal defect of the excitation light source.

4. The optical apparatus according to claim 1, where in the OSC unit transmits the information of the random failure of the excitation light source including an output power decrement of the excitation light source.

5. The optical apparatus according to claim 4, wherein the OSC unit transmits the information of the random failure of the excitation light source including a signal output decrement in the optical amplifiers to all the stations on the system.

6. The optical apparatus according to claim 1, wherein,
the OSC unit transmits the OSC optical signal including quality information on received light; and
the output power of the excitation light is controlled by the quality information of other optical apparatus received by the OSC unit.

7. A method of optical amplification, comprising:
providing an optical amplifier including an optical amplification medium and an excitation light source;
supplying an excitation light to the optical amplification medium with the excitation light source;
providing an optical supervisory channel (OSC) unit;
receiving OSC optical signals from, and transmitting the OSC optical signals to, an up transmission line and a down transmission line at the optical supervisory channel (OSC) unit;
detecting an output power decrease of the excitation light source due to an random failure;
keeping a driving condition of the excitation light unchanged and transmitting an information of the random failure of the excitation light source via the OSC optical signals to the up transmission line and the down transmission line;
receiving an information of an random failure of an excitation light source in a second optical apparatus connected to the up transmission line and the down transmission line; and
increasing the output light power of the excitation light source in response to the information of the random failure of the excitation light source in the second optical apparatus.
